(19) United States
(12) Patent Application Publication
(10) Pub. No.: US 2025/0110221 A1
(43) Pub. Date: Apr. 3, 2025

(54) PHOTOELECTRIC CONVERSION DEVICE AND RANGING DEVICE

(71) Applicant: CANON KABUSHIKI KAISHA, Tokyo (JP)

(72) Inventor: SATOSHI OMODANI, Tokyo (JP)

(21) Appl. No.: 18/807,012

(22) Filed: Aug. 16, 2024

(30) Foreign Application Priority Data
Sep. 28, 2023 (JP) 2023-167378

(51) Int. Cl. G01S 7/4865; G01S 7/481; G01S 17/931

(52) U.S. Cl. CPC G01S 7/4865; G01S 7/4816; G01S 17/931

(57) ABSTRACT

A photoelectric conversion device includes a light receiving unit configured to generate a light reception pulse signal in response to incidence of light, a time information acquisition unit configured to acquire, for each periodic light emission of a light emitting unit, a first time count value indicating an elapsed time from a light emission of the light emitting unit to an input of the light reception pulse signal, and a second time count value indicating a pulse width of the light reception pulse signal, and a weight determination unit configured to generate a weight value corresponding to the second time count value as a signal used to generate information indicating a relationship between each of the first time count values and a light reception frequency.

### BACKGROUND

### Field

The present disclosure relates to a photoelectric conversion device and a ranging device.

### Description of the Related Art

As one of ranging methods for measuring a distance to an object using light, a ranging method called TOF (time-of-flight) method is known. The TOF method is a method of measuring a distance to an object based on a time from emission of light toward the object to detection of light reflected by the object. Japanese Patent Application Laid-Open No. 2021-001764 describes a ranging device that measures a distance to an object by applying the TOF method to a photon detection sensor using SPAD (Single Photon Avalanche Diode) elements. In Japanese Patent Application Laid-Open No. 2021-001764, processing corresponding to a weight corresponding to the number of reactions of a light receiving element according to incidence of photon on a pixel is performed on a count value of a time from when a light source emits light to when the photon is incident on the pixel, thereby improving distance measurement accuracy.

However, in the technique described in Japanese Patent Application Laid-Open No. 2021-001764, the weight according to the number of reactions of the light receiving element cannot be appropriately reflected depending on the incident mode of the photons to the pixel, and the distance measurement accuracy cannot be improved in some cases.

### SUMMARY OF THE INVENTION

An object of the present invention is to provide a photoelectric conversion device capable of outputting an appropriate signal according to the incidence frequency of photons on a pixel, and a ranging device having high ranging accuracy using such the photoelectric conversion device.

According to one disclosure of the present specification, there is provided a photoelectric conversion device including a light receiving unit configured to generate a light reception pulse signal in response to incidence of light, a time information acquisition unit configured to acquire, for each periodic light emission of a light emitting unit, a first time count value indicating an elapsed time from a light emission of the light emitting unit to an input of the light reception pulse signal, and a second time count value indicating a pulse width of the light reception pulse signal, and a weight determination unit configured to generate a weight value corresponding to the second time count value as a signal used to generate information indicating a relationship between each of the first time count values and a light reception frequency.

Further, according to another disclosure of the present specification, there is provided a ranging device including a light receiving unit configured to generate a light reception pulse signal in response to incidence of light, a time information acquisition unit configured to acquire, for each periodic light emission of a light emitting unit, a first time count value indicating an elapsed time from a light emission of the light emitting unit to an input of the light reception pulse signal, and a second time count value indicating a pulse width of the light reception pulse signal, a weight determination unit configured to generate, for each periodic light emission of the light emitting unit, a weight value corresponding to the second time count value, an information generation unit configured to generate information indicating a relationship between each of the first time count values and a light reception frequency by accumulating, for each periodic light emission of the light emitting unit, the weight value output from the weight determination unit as a value representing the light reception frequency for the corresponding first time count value, and a distance information acquisition unit configured to acquire distance information corresponding to a first time count value having largest accumulated value of the weight value among the first time count values.

Further, according to still another disclosure of the present specification, there is provided an information processing device including an input unit to which a first time count value indicating an elapsed time from a light emission of a light emitting unit to a reception of a light reception pulse signal, and a second time count value indicating a pulse width of the light reception pulse signal are periodically input, a weight determination unit configured to generate, for each reception of the first time count value and the second time count value, a weight value corresponding to the second time count value, an information generation unit configured to generate information indicating a relationship between each of the first time count values and a light reception frequency by accumulating, for each reception of the first time count value and the second time count value, the weight value output from the weight determination unit as a value representing the light reception frequency for the corresponding first time count value, and a distance information acquisition unit configured to acquire distance information corresponding to a first time count value having largest accumulated value of the weight value among the first time count values.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a ranging device according to a first embodiment of the present invention.

FIG. 2 is a block diagram illustrating a configuration example of a photoelectric conversion device according to the first embodiment of the present invention.

FIG. 3 is a block diagram illustrating a configuration example of a pixel in the photoelectric conversion device according to the first embodiment of the present invention.

FIG. 4A and FIG. 4B are diagrams illustrating a basic operation of the pixel in the photoelectric conversion device according to the first embodiment of the present invention.

FIG. 5 is a block diagram illustrating a configuration example of a signal processing unit in the ranging device according to the first embodiment of the present invention.

FIG. 6 is a diagram illustrating an example of histogram information.

FIG. 7 is a timing chart illustrating the operation of the ranging device according to the first embodiment of the present invention.

FIG. 8 is a diagram illustrating an example of processing of a weight determination unit in the ranging device according to the first embodiment of the present invention.

FIG. 9 is a block diagram illustrating a configuration example of a signal processing unit in a ranging device according to a second embodiment of the present invention.

FIG. 10 is a timing chart illustrating the operation of the ranging device according to the second embodiment of the present invention.

FIG. 11 is a diagram illustrating an example of processing of a weight determination unit in a ranging device according to a third embodiment of the present invention.

FIG. 12 and FIG. 13 are diagrams illustrating an example of the processing of a weight determination unit in a ranging device according to a fourth embodiment of the present invention.

FIG. 14A and FIG. 14B are diagrams illustrating a configuration example of a movable object according to a fifth embodiment of the present invention.

### DESCRIPTION OF THE EMBODIMENTS

### First Embodiment

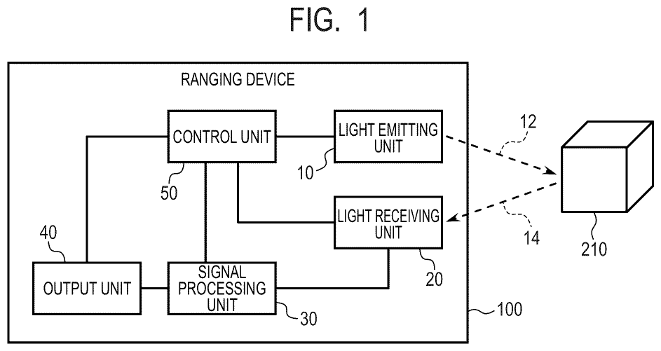

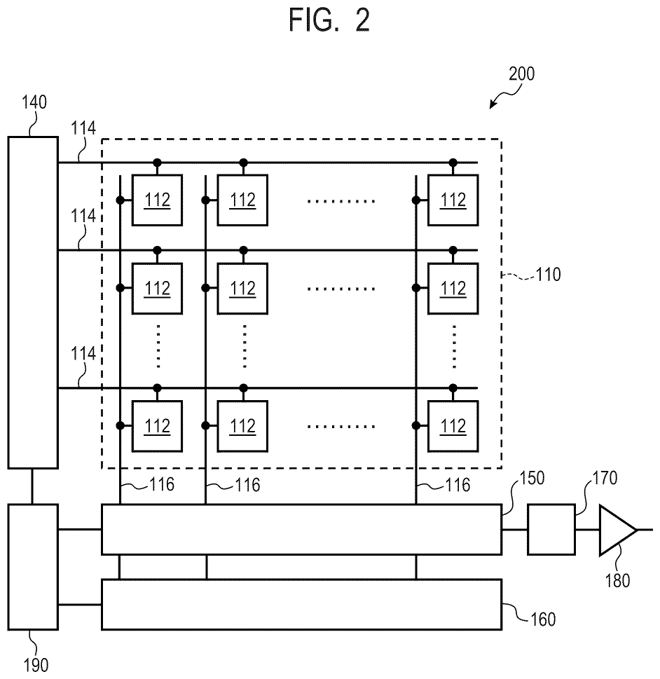

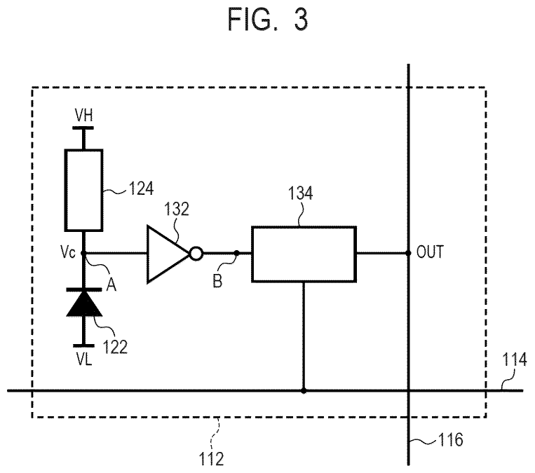

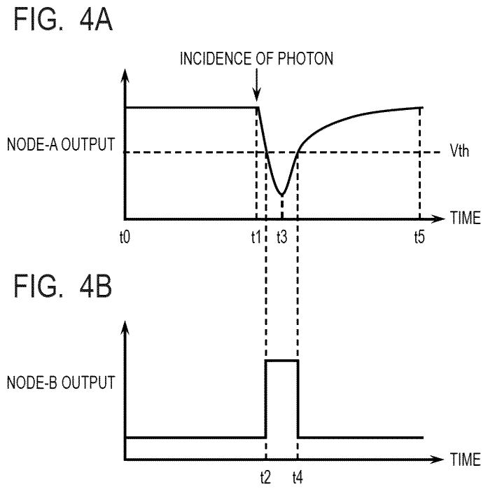

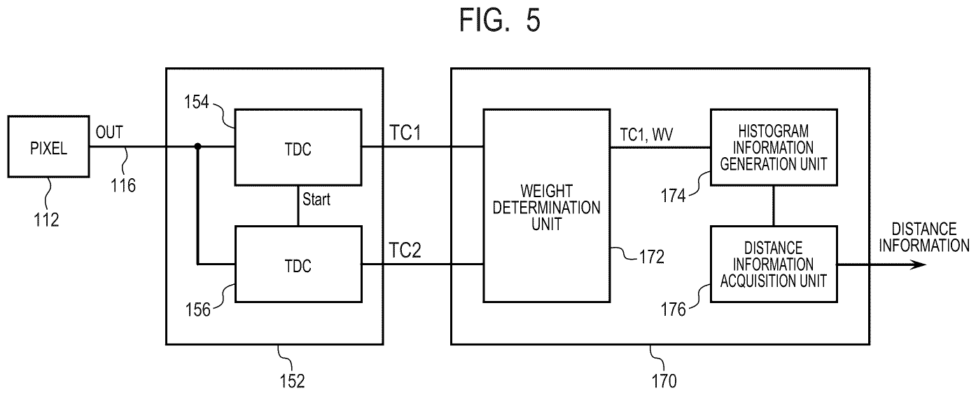

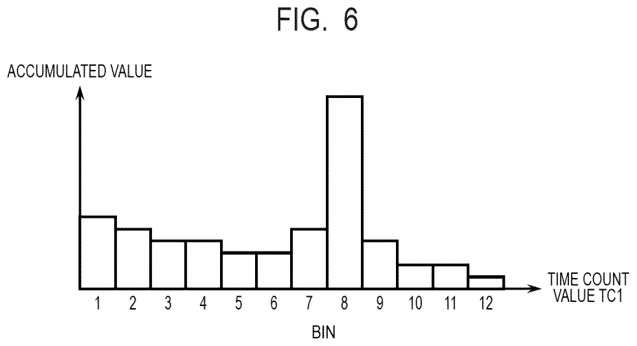

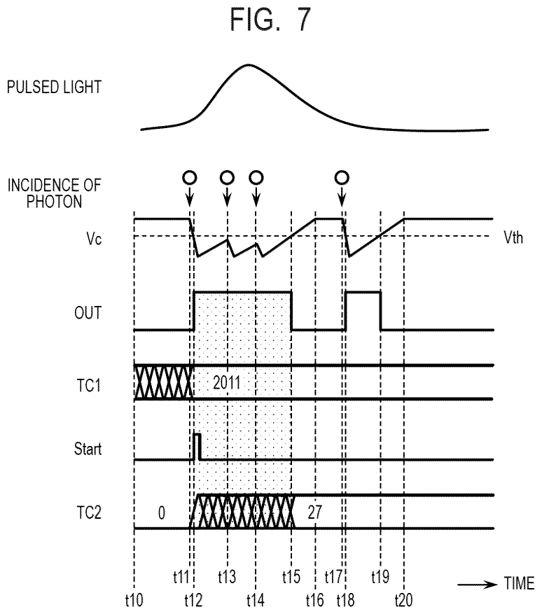

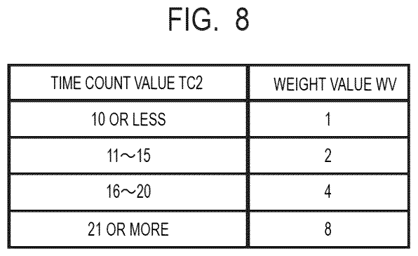

A ranging device and a ranging method according to a first embodiment of the present invention will be described with reference to FIG. 1 to FIG. 8. FIG. 1 is a block diagram illustrating a schematic configuration of a ranging device according to the present embodiment. FIG. 2 is a block diagram illustrating a configuration example of a photoelectric conversion device according to the present embodiment. FIG. 3 is a block diagram illustrating a configuration example of a pixel in the photoelectric conversion device according to the present embodiment. FIG. 4A and FIG. 4B are diagrams illustrating a basic operation of the pixel in the photoelectric conversion device according to the present embodiment. FIG. 5 is a block diagram illustrating a configuration example of a signal processing unit in the ranging device according to the present embodiment. FIG. 6 is a diagram illustrating an example of histogram information. FIG. 7 is a timing chart illustrating the operation of the ranging device according to the present embodiment. FIG. 8 is a diagram illustrating an example of processing of a weight determination unit in the ranging device according to the present embodiment.

First, a schematic configuration of a ranging device according to the present embodiment will be described with reference to FIG. 1. As illustrated in FIG. 1, the ranging device 100 according to the present embodiment may include a light emitting unit 10, a light receiving unit 20, a signal processing unit 30, an output unit 40, and a control unit 50. The light emitting unit 10 is connected to the control unit 50. The light receiving unit 20 is connected to the signal processing unit 30 and the control unit 50. The signal processing unit 30 is connected to the light receiving unit 20, the output unit 40, and the control unit 50. The output unit 40 is connected to the signal processing unit 30 and the control unit 50. The control unit 50 is connected to the light emitting unit 10, the light receiving unit 20, the signal processing unit 30, and the output unit 40.

The light emitting unit 10 includes a light emitting element (not illustrated) and has a function of emitting pulsed light (irradiation light 12) such as laser light emitted from the light emitting element to a measurement target region. As the light emitting element constituting the light emitting unit 10, for example, an element capable of high-speed modulation such as an LED (Light Emitting Diode) or an LD (Laser Diode) may be preferably used. The light emitting element may be a VCSEL (Vertical Cavity Surface Emitting Laser) or a surface light emitting element in which the VCSELs are arranged in an array.

The light emitting unit 10 is preferably configured to emit light of a uniform amount to the measurement target region, and may further include an optical element, for example, a lens, for optically converting the light emitted from the light emitting element to irradiate the measurement target region.

The light receiving unit 20 has a function of detecting light incident from the measurement target region. The light incident on the light receiving unit 20 may include, in addition to the environmental light in the measurement target region, light (reflected light 14) of the irradiation light 12 reflected by the object 210 in the measurement target region. The light receiving unit 20 includes a plurality of light receiving elements two-dimensionally arranged. Each of the light receiving elements converts the incident optical signal into an electrical signal and outputs the electrical signal to the signal processing unit 30. A pulse signal corresponding to the reflected light 14 is superimposed on the electrical signal output from the light receiving element to the signal processing unit 30. As the light receiving element, for example, a SPAD (Single Photon Avalanche Diode) sensor, a CMOS (Complementary Metal Oxide Semiconductor) sensor, or the like may be applied. The light receiving unit 20 may further include an optical element, such as a lens, for efficiently guiding the reflected light 14 to the light receiving element.

The control unit 50 generates a light emission control signal for controlling the light emission timing of the pulsed light in the light emitting unit 10 and transmits the generated light emission control signal to the light emitting unit 10. Further, the control unit 50 generates a count control signal synchronized with the light emission control signal and transmits the generated count control signal to the signal processing unit 30. The control unit 50 also has a function of controlling the entire operation of the ranging device 100.

The signal processing unit 30 has a function of acquiring distance information to an object 210 based on signals received from the light receiving unit 20 and the control unit 50. A specific configuration and operation of the signal processing unit 30 will be described later. The output unit 40 has a function of outputting the distance information received from the signal processing unit 30 to the outside.

The ranging device 100 according to the present embodiment may include a photoelectric conversion device 200 illustrated in, e.g., FIG. 2 but not necessarily limited thereto. The photoelectric conversion device 200 constitutes at least the light receiving unit 20 among a plurality of functional blocks of the ranging device 100 illustrated in FIG. 1. In the present embodiment, the photoelectric conversion device 200 will be described by taking, as an example, a case where the photoelectric conversion device 200 includes at least a part of the functions of the signal processing unit 30, the output unit 40, and the control unit 50 in addition to the light receiving unit 20. The functions of the signal processing unit 30, the output unit 40, and the control unit 50 may be provided in a device different from the photoelectric conversion device 200 including the light receiving unit 20.

As illustrated in, e.g., FIG. 2, the photoelectric conversion device 200 may include a pixel unit 110, a pixel driving unit 140, a time information acquisition unit 150, a horizontal scanning circuit unit 160, a signal processing circuit unit 170, an output circuit unit 180, and a control unit 190. The pixel unit 110 is connected to the pixel driving unit 140 and the time information acquisition unit 150. The pixel driving unit 140 is connected to the pixel unit 110 and the control unit 190. The time information acquisition unit 150 is connected to the pixel unit 110, the horizontal scanning circuit unit 160, the signal processing circuit unit 170, and the control unit 190. The horizontal scanning circuit unit 160 is connected to the control unit 190. The signal processing circuit unit 170 is connected to the time information acquisition unit 150 and the output circuit unit 180. The output circuit unit 180 is connected to the signal processing circuit unit 170. The control unit 190 is connected to the pixel driving unit 140, the time information acquisition unit 150, and the horizontal scanning circuit unit 160.

Among the functional blocks of the ranging device 100, the light receiving unit 20 may be configured by the pixel unit 110 of the photoelectric conversion device 200. The signal processing unit 30 may include the time information acquisition unit 150 and the signal processing circuit unit 170 of the photoelectric conversion device 200. The output unit 40 may be configured by an output circuit unit 180. The control unit 50 may include the pixel driving unit 140, the horizontal scanning circuit unit 160, and the control unit 190.

The pixel unit 110 is provided with a plurality of pixels 112 arranged in an array so as to form a plurality of rows and a plurality of columns. As described later, each pixel 112 may include a photoelectric conversion unit including a photoelectric conversion element and a pixel signal processing unit that processes a signal output from the photoelectric conversion unit. Note that the number of pixels 112 included in the pixel unit 110 is not particularly limited. For example, like a general digital camera, the pixel unit 110 may include a plurality of pixels 112 arranged in an array of several thousand rows×several thousand columns. Alternatively, the pixel unit 110 may include a plurality of pixels 112 arranged in one row or one column. Alternatively, the pixel unit 110 may include one pixel 112.

In each row of the pixel array of the pixel unit 110, a control line 114 is arranged so as to extend in a first direction (lateral direction in FIG. 1). Each of the control lines 114 is connected to the pixels 112 arranged in the first direction on the corresponding row, respectively, and forms a signal line common to these pixels 112. The first direction in which the control lines 114 extend may be referred to as a row direction or a horizontal direction. Each of the control lines 114 may include a plurality of signal lines for supplying a plurality of types of control signals to the pixels 112. The control line 114 of each row is connected to the pixel driving unit 140.

In each column of the pixel array of the pixel unit 110, an output line 116 is arranged so as to extend in a second direction (vertical direction in FIG. 1) intersecting the first direction. Each of the output lines 116 is connected to the pixels 112 arranged in the second direction on the corresponding column, respectively, and forms a signal line common to these pixels 112. The second direction in which the output lines 116 extend may be referred to as a column direction or a vertical direction. Each of the output lines 116 may include a plurality of signal lines.

The control line 114 of each row is connected to the pixel driving unit 140. The pixel driving unit 140 is a control circuit having a function of generating a control signal for driving the pixel 112 in response to a control signal output from the control unit 190 and supplying the generated control signal to the pixel 112 via the control line 114. A logic circuit such as a shift register, or an address decoder may be used as the pixel driving unit 140. The pixel driving unit 140 sequentially scans the pixels 112 in the pixel unit 110 in units of rows and makes the pixels 112 output pixel signals held therein to the time information acquisition unit 150 via the output line 116.

The output line 116 of each column is connected to the time information acquisition unit 150. The time information acquisition unit 150 includes a plurality of column information acquisition units (not illustrated) provided corresponding to each column of the pixel array of the pixel unit 110 and has a function of performing a time counting operation according to the pixel signal of the pixel 112 of each column output in units of rows from the pixel unit 110 via the output line 116. A specific configuration and operation of the time information acquisition unit 150 will be described later.

The horizontal scanning circuit unit 160 is a control unit that generates a control signal for reading out a signal corresponding to a measurement result from a measurement unit of each column of the time information acquisition unit 150 in response to a control signal output from the control unit 190 and supplies the generated control signal to the time information acquisition unit 150. A logic circuit such as a shift register, or an address decoder may be used as the horizontal scanning circuit unit 160. The horizontal scanning circuit unit 160 sequentially scans the column information acquisition unit of each column of the time information acquisition unit 150 and makes the time information acquisition unit 150 sequentially output the signal held in the column information acquisition unit of each column to the signal processing circuit unit 170.

The signal processing circuit unit 170 has a function of performing predetermined signal processing on a signal transmitted from the time information acquisition unit 150. A specific configuration and operation of the signal processing circuit unit 170 will be described later.

The output circuit unit 180 includes an external interface circuit and is a circuit unit for outputting a signal output from the signal processing circuit unit 170 to the outside of the photoelectric conversion device 200. The external interface circuit included in the output circuit unit 180 is not particularly limited. As the external interface circuit, for example, a SerDes (SERializer/DESerializer) transmission circuit may be applied. The SerDes transmission circuit is, for example, an LVDS (Low Voltage Differential Signaling) circuit or an SLVS (Scalable Low Voltage Signaling) circuit.

The control unit 190 is a control circuit that generates control signals for controlling the operations and timings thereof of the pixel driving unit 140, the time information acquisition unit 150, and the horizontal scanning circuit unit 160, and supplies the control signals to these functional blocks. At least a part of the control signals for controlling the operations and timings thereof of the pixel driving unit 140, the time information acquisition unit 150, and the horizontal scanning circuit unit 160 may be supplied from the outside of the photoelectric conversion device 200. For example, the function of the control unit 190 may be included in the control unit 50 of the ranging device 100.

Each pixel 112 may include a photoelectric conversion element 122, a quenching circuit 124, a waveform shaping circuit 132, and a selection circuit 134 as illustrated in, e.g., FIG. 3.

The photoelectric conversion element 122 may be an avalanche photodiode (hereinafter referred to as “APD”). An anode of the APD constituting the photoelectric conversion element 122 is connected to a node to which a voltage VL is supplied. A cathode of the APD constituting the photoelectric conversion element 122 is connected to one terminal of the quenching circuit 124. The other terminal of the quenching circuit 124 is connected to a node to which a voltage VH higher than the voltage VL is supplied. The voltage VL and the voltage VH are set so that a reverse bias voltage sufficient for the APD to perform avalanche multiplication operation is applied. In one example, a negative high voltage is applied as the voltage VL, and a positive voltage comparable to the power supply voltage is applied as the voltage VH. For example, the voltage VL is −30 V, and the voltage VH is 1 V.

The photoelectric conversion element 122 may be configured by an APD as described above. When a reverse bias voltage sufficient to perform the avalanche multiplication operation is supplied to the APD, charge generated by light incident on the APD causes avalanche multiplication, and an avalanche current is generated. The operation modes in a state where the reverse bias voltage is supplied to the APD include a Geiger mode and a linear mode. The Geiger mode is an operation mode in which a voltage applied between the anode and the cathode is set to a reverse bias voltage larger than the breakdown voltage of the APD. The linear mode is an operation mode in which a voltage applied between an anode and a cathode is set to a reverse bias voltage close to or lower than a breakdown voltage of the APD. An APD that operates in Geiger mode is referred to as SPAD (Single Photon Avalanche Diode). The APD constituting the photoelectric conversion element 122 may operate in a linear mode or a Geiger mode.

The quenching circuit 124 has a function of converting a change in the avalanche current generated in the photoelectric conversion element 122 into a voltage signal. In addition, the quenching circuit 124 functions as a load circuit (quenching circuit) at the time of signal multiplication by avalanche multiplication and has a function of suppressing avalanche multiplication by reducing a voltage applied to the photoelectric conversion element 122. The operation in which the quenching circuit 124 suppresses avalanche multiplication is called a quenching operation. The quenching circuit 124 has a function of returning the voltage supplied to the photoelectric conversion element 122 to the voltage VH by flowing a current corresponding to the voltage drop due to the quench operation. The operation of returning the voltage supplied from the quenching circuit 124 to the photoelectric conversion element 122 to the voltage VH is referred to as a recharge operation. The quenching circuit 124 may be configured by a resistor element, a MOS transistor, or the like.

The waveform shaping circuit 132 includes an input node connected to a connection node (node-A) between the photoelectric conversion element 122 and the quenching circuit 124, and an output node. The waveform shaping circuit 132 has a function of converting an analog signal supplied from the node-A into a pulse signal. The waveform shaping circuit 132 may be configured by a logic circuit including a NOT circuit (inverter circuit), a NOR circuit, a NAND circuit, or the like. The output node of the waveform shaping circuit 132 is connected to the selection circuit 134.

The selection circuit 134 has a function of switching an electrical connection state (connection or disconnection) between the waveform shaping circuit 132 and the output line 116. The selection circuit 134 switches the connection state between the waveform shaping circuit 132 and the output line 116 in accordance with a control signal supplied from the pixel driving unit 140 via the control line 114. The selection circuit 134 may include a buffer circuit for outputting a signal.

Next, a basic operation of the pixel 112 in the photoelectric conversion device 200 according to the present embodiment will be described with reference to FIG. 4A and FIG. 4B. FIG. 4A and FIG. 4B are diagrams illustrating a basic operation of the photoelectric conversion unit in the photoelectric conversion device according to the present embodiment. FIG. 4A illustrates a waveform of a signal at an input node (node-A) of the waveform shaping circuit 132, and FIG. 4B illustrates a waveform of a signal at an output node (node-B) of the waveform shaping circuit 132. Here, in order to simplify the description, it is assumed that the waveform shaping circuit 132 is configured by an inverter circuit.

At time t0, a reverse bias voltage having a potential difference corresponding to (VH-VL) is applied to the photoelectric conversion element 122. Although a reverse bias voltage sufficient to cause avalanche multiplication is applied between the anode and the cathode of the APD constituting the photoelectric conversion element 122, no carrier serving as a seed of avalanche multiplication exists in a state where photon is not incident on the photoelectric conversion element 122. Therefore, avalanche multiplication does not occur in the photoelectric conversion element 122, and no current flows through the photoelectric conversion element 122.

At the subsequent time t1, it is assumed that a photon is incident on the photoelectric conversion element 122. When a photon enters the photoelectric conversion element 122, an electron-hole pair is generated by photoelectric conversion, avalanche multiplication occurs using these carriers as seeds, and an avalanche multiplication current flows through the photoelectric conversion element 122. Thus, the voltage of the node-A starts to drop. When the voltage drop amount of the node-A becomes large and the avalanche multiplication is stopped at time t3, the voltage level of the node-A no longer drops.

When the avalanche multiplication in the photoelectric conversion element 122 is stopped, a current that compensates for the voltage drop flows from the node to which the voltage VH is supplied to the node-A through the quenching circuit 124, and the voltage of the node-A gradually increases. Thereafter, at time t5, the node-A is settled to the original voltage level.

The waveform shaping circuit 132 binarizes the signal input from the node-A according to a predetermined determination threshold value Vth, and outputs the signal from the node-B. Specifically, the waveform shaping circuit 132 outputs a low-level signal from the node-B when the voltage level of the node-A exceeds the determination threshold value Vth, and outputs a high-level signal from the node-B when the voltage level of the node-A is equal to or lower than the determination threshold value. For example, as illustrated in FIG. 4A, it is assumed that the voltage of the node-A is equal to or lower than the determination threshold value in the period from time t2 to time t4. In this case, as illustrated in FIG. 4B, the signal level at the node-B becomes low-level in the period from the time t0 to the time t2 and the period from the time t4 to the time t5, and becomes high-level in the period from the time t2 to the time t4.

Thus, the analog signal input from the node-A is waveform-shaped into a digital signal by the waveform shaping circuit 132. A pulse signal output from the waveform shaping circuit 132 in response to incidence of a photon on the photoelectric conversion element 122 is called a light reception pulse signal.

Next, a configuration example and a basic operation of the signal processing unit 30 in the ranging device 100 according to the present embodiment will be described with reference to FIG. 5 and FIG. 6. As described above, the signal processing unit 30 may include the time information acquisition unit 150 and the signal processing circuit unit 170 of the photoelectric conversion device 200. In FIG. 5, attention is paid to the processing of a pixel signal output from one pixel 112, and among the functional blocks constituting the signal processing unit 30, the functional blocks involved in the processing of the pixel signal are extracted and illustrated.

The time information acquisition unit 150 includes a plurality of column information acquisition units 152 provided corresponding to each column of the pixel array of the pixel unit 110. Each of the plurality of column information acquisition units 152 includes time-to-digital conversion units (TDCs) 154 and 156. The signal processing circuit unit 170 includes a weight determination unit 172, a histogram information generation unit 174, and a distance information acquisition unit 176. The TDC 154 is connected to the output line 116 and the TDC 156. The TDC 156 is connected to the output line 116 and the TDC 154. The weight determination unit 172 is connected to the TDCs 154 and 156 and the histogram information generation unit 174. The histogram information generation unit 174 is connected to the weight determination unit 172 and the distance information acquisition unit 176. The distance information acquisition unit 176 is connected to the histogram information generation unit 174.

The signal OUT output from the pixel 112 is input to the TDC 154 and the TDC 156 of the column information acquisition unit 152 via the output line 116 of the corresponding column. Each of the TDC 154 and the TDC 156 performs time counting in a predetermined period. The time counting may be performed by, for example, a method of counting the number of pulses superimposed on the clock signal. For example, in the case of using a clock signal having a period of 1 nanosecond, when the time count value increases from 0 to 10, 10 nanoseconds have elapsed.

Specifically, the TDC 154 performs time counting in a period from the timing at which the count control signal synchronized with the light emission control signal transmitted to the light emitting unit 10 is received from the control unit 190 to the timing at which the light reception pulse signal superimposed on the signal OUT is first received. Then, the TDC 154 outputs a signal Start to the TDC 156 at the timing when the light reception pulse signal is first received, that is, at the timing when the time counting operation is stopped in response to the light reception pulse signal.

In addition, the TDC 154 outputs the count value of the clock pulse in the period from the timing of receiving the count control signal to the timing of receiving the light reception pulse signal to the weight determination unit 172 as a time count value TC1. The time count value TC1 corresponds to an elapsed time from the light emission of the light emitting unit 10 to the input of the light reception pulse signal.

The TDC 156 counts the time period from the timing when the signal Start is received to the timing when the light reception pulse signal falls next. The TDC 156 outputs the count value of the clock pulse in the period in which the light reception pulse signal is received to the weight determination unit 172 as the time count value TC2. The time count value TC2 corresponds to the pulse width of the light reception pulse signal.

The weight determination unit 172 outputs the time count value TC1 received from the TDC 154 and a weight value WV including a weight corresponding to the time count value TC2 received from the TDC 156 to the histogram information generation unit 174 as a signal for each pixel 112.

The histogram information generation unit 174 generates information obtained by accumulating the weight value WV for each time count value TC1 for each pixel 112 based on the signal from the weight determination unit 172. Since this information represents the relationship between the class of time (hereinafter referred to as “bin”) and the light reception frequency in each bin, this information is regarded as a histogram representing the relationship between the class and the frequency and is referred to as histogram information in this specification. The histogram information may be information in which the time count value TC1 and the accumulated value are associated with each other, and the data configuration thereof does not need to be the histogram itself.

FIG. 6 is a diagram illustrating an example of histogram information generated by the histogram information generation unit 174 as a histogram. In the histogram of FIG. 6, the horizontal axis represents the number of the bin indicating the class of the time count value TC1, and the vertical axis represents the frequency (accumulated value of the weight value WV) in each bin. In the histogram information of FIG. 6, the accumulated value has a peak in the time count value TC1 corresponding to the bin 8.

The distance information acquisition unit 176 calculates distance information to the object 210 for each pixel 112 based on the time count value TC1 of the bin having the peak accumulated value. Here, the distance D [m] to the object 210 may be calculated by the following Expression (1). In the Expression (1), t is a time count value (unit: second) corresponding to a bin having a peak accumulated value, and c is a light velocity (2.998×10⁸ [m/sec]).

$$D = c \times t / 2 [ m ] \qquad ( 1 )$$

For example, when the resolution of the time count value TC1 is set to 0.1 nanoseconds, since the bin 8 indicates the peak of the accumulated value, the distance D to the object 210 may be calculated to be 120 [mm] from the Expression (1).

Next, the operation of the ranging device 100 according to the present embodiment will be described in more detail with reference to FIG. 1 to FIG. 8.

The ranging device 100 according to the present embodiment is a dToF (direct time of Flight) type LiDAR (Light Detection And Ranging) system. In this system, the distance to the object is calculated by measuring the time from the emission timing of the laser beam to the reception timing of the reflected light. More accurate distance information to the object may be obtained by periodically emitting the pulsed light from the light emitting unit 10 and obtaining the frequency distribution for each predetermined time width by obtaining the time information for each emission of the pulsed light.

When the ranging device 100 according to the present embodiment is configured using the photoelectric conversion device 200 of FIG. 2, the ranging operation is performed for each row of the pixel unit 110. By controlling the selection circuit 134 of the pixels 112 in a predetermined row to be in an ON state by a control signal from the pixel driving unit 140, it is possible to output a light reception pulse signal from the pixels 112 in the row to the time information acquisition unit 150. By sequentially selecting the pixels 112 in each row by the pixel driving unit 140, it is possible to acquire distance information corresponding to each of the plurality of pixels 112 included in the pixel unit 110.

The signal OUT output from the pixel 112 of each column is input to the column information acquisition unit 152 of the corresponding column via the output line 116 of the corresponding column. The column information acquisition unit 152 generates and holds the time count values TC1 and TC2 based on the signal OUT received from the pixel 112 and the light emission control signal received from the control unit 190.

The time information acquisition unit 150 sequentially transfers the time count values TC1 and TC2 held by the column information acquisition unit 152 of each column to the signal processing circuit unit 170 in accordance with the control signal from the horizontal scanning circuit unit 160.

The weight determination unit 172 of the signal processing circuit unit 170 generates the weight value WV based on the time count values TC1 and TC2 acquired from the time information acquisition unit 150, and outputs the time count value TC1 and the weight value WV to the histogram information generation unit 174. The histogram information generation unit 174 accumulates the weight value WV output for each light emission of the pulsed light from the weight determination unit 172 for each time count value TC1 and generates histogram information for each pixel 112.

FIG. 7 is a timing chart illustrating a driving example of the ranging device 100 according to the present embodiment. FIG. 7 illustrates the waveform of the pulsed light reflected by the object 210 and then incident on the light receiving unit 20, the incident timing of the photon, and the waveforms of the cathode voltage Vc, the signal OUT, the time count value TC1, the signal Start, and the time count value TC2.

The time t10 is an arbitrary time after the pulsed light is emitted from the light emitting unit 10 until the pulsed light is detected as the reflected light 14 by the light receiving unit 20. At the time t10, the photoelectric conversion element 122 is in a standby state in which avalanche multiplication is possible, and the cathode voltage Vc is a voltage corresponding to the voltage VH. The signal OUT is at low-level in response to the cathode voltage Vc higher than the determination threshold value Vth. The time count value TC1 indicates a predetermined count value corresponding to the elapsed time from a timing at which the pulsed light is emitted from the light emitting unit 10, that is, a timing at which the count control signal is received from the control unit 190. The signal Start is at low-level in response to the low-level signal OUT. The TDC 156 is in a reset state, and the time count value TC2 is 0.

It is assumed that the reflected light 14 is incident on the light receiving unit 20 after the time t10, and photons are incident on a certain pixel 112 at timings of times t11, t13, t14, and t17, for example, as illustrated in FIG. 7.

When a photon enters the photoelectric conversion element 122 at time t11, an electron-hole pair is generated by photoelectric conversion, avalanche multiplication occurs using these carriers as seeds, and an avalanche multiplication current flows through the photoelectric conversion element 122. As a result, a voltage drop occurs, and the cathode voltage Vc starts to drop.

When the cathode voltage Vc falls below the determination threshold value Vth at the subsequent time t12, the signal level of the signal OUT output from the waveform shaping circuit 132 transitions from low-level to high-level. The TDC 154 stops the time counting operation in response to the rise of the signal OUT and causes the signal Start to transition from low-level to high-level. The TDC 156 starts a time counting operation in response to the rise of the signal Start.

After the time t12, when the voltage drop amount of the cathode of the APD becomes large and the avalanche multiplication in the photoelectric conversion element 122 stops, the voltage level of the cathode voltage Vc does not drop any more. When the avalanche multiplication in the photoelectric conversion element 122 is stopped, a current flows from the node to which the voltage VL is supplied to the cathode of the APD through the photoelectric conversion element 122, and the cathode voltage Vc gradually increases.

If a photon enters the photoelectric conversion element 122 again at time t13 before the cathode voltage Vc reaches the determination threshold value Vth, avalanche multiplication occurs in the photoelectric conversion element 122, and the cathode voltage Vc starts to drop again. In such a case, since the cathode voltage Vc does not exceed the determination threshold value Vth, the signal level of the signal OUT is maintained at high-level.

After the time t13, when the voltage drop amount of the cathode of the APD becomes large and the avalanche multiplication in the photoelectric conversion element 122 stops, the voltage level of the cathode voltage Vc does not drop any more. When the avalanche multiplication in the photoelectric conversion element 122 is stopped, a current flows from the node to which the voltage VL is supplied to the cathode of the APD through the photoelectric conversion element 122, and the cathode voltage Vc gradually increases.

If a photon enters the photoelectric conversion element 122 again at time t14 before the cathode voltage Vc reaches the determination threshold value Vth, avalanche multiplication occurs in the photoelectric conversion element 122, and the cathode voltage Vc starts to drop again. Also in this case, since the cathode voltage Vc does not exceed the determination threshold value Vth, the signal level of the signal OUT is maintained at high-level.

At the subsequent time t15, when the cathode voltage Vc reaches the determination threshold value Vth, the signal level of the signal OUT transitions from high-level to low-level. The TDC 156 stops the time counting operation in response to the fall of the signal OUT. That is, the TDC 156 performs the time counting operation in the period from the time t12 to the time t15. The period in which the TDC 156 performs the time counting operation corresponds to a pulse width of the light reception pulse signal detected first after the light emission of the light emitting unit 10, that is a period in which the signal OUT becomes high-level continuously.

At the subsequent time t16, the cathode voltage Vc is settled to the original voltage corresponding to the voltage VH. The photoelectric conversion element 122 enters a standby state in which avalanche multiplication can be performed.

At the subsequent time t17, when a photon enters the photoelectric conversion element 122, an electron-hole pair is generated by photoelectric conversion, avalanche multiplication occurs using these carriers as seeds, and an avalanche multiplication current flows through the photoelectric conversion element 122. When this avalanche multiplication current flows through the quenching circuit 124, a voltage drop occurs by the quenching circuit 124, and the cathode voltage Vc starts to drop.

At the subsequent time t18, when the cathode voltage Vc falls below the determination threshold value Vth, the signal level of the signal OUT output from the waveform shaping circuit 132 transitions from low-level to high-level. The TDC 154 stops the time counting operation at the time t12, does not respond to the second and subsequent rises of the signal OUT, and does not output the signal Start to the TDC 156.

After the time t18, when the voltage drop amount of the cathode of the APD increases and the avalanche multiplication in the photoelectric conversion element 122 stops, the voltage level of the cathode voltage Vc does not drop any more. When the avalanche multiplication in the photoelectric conversion element 122 stops, the cathode voltage Vc gradually increases.

At the subsequent time t19, when the cathode voltage Vc reaches the determination threshold value Vth, the signal level of the signal OUT transitions from high-level to low-level.

At the subsequent time t20, the cathode voltage Vc is settled to the original voltage corresponding to the voltage VH. The photoelectric conversion element 122 enters a standby state in which avalanche multiplication can be performed. Thereafter, until the count control signal corresponding to the next light emission timing of the light emitting unit 10 is received, the same operation as that, for example, from the time t16 to the time t20 is repeated.

When the information acquisition period corresponding to one pulsed light emission elapses, the time information acquisition unit 150 sequentially transfers the time count values TC1 and TC2 held by the column information acquisition unit 152 of each column to the signal processing circuit unit 170 according to the control signal from the horizontal scanning circuit unit 160. The time count values TC1 and TC2 transferred to the signal processing circuit unit 170 are input to the weight determination unit 172. Here, it is assumed that the time count value TC1 held by the TDC 154 is 2011, and the time count value TC2 held by the TDC 156 is 27.

The weight determination unit 172 determines the weight value WV based on the time count value TC2 acquired from the time information acquisition unit 150. Although a method of determining the weight value WV is not particularly limited, for example, a lookup table indicating a correspondence relationship between the time count value TC2 and the weight value WV may be used. A lookup table is prepared in advance, and the weight value WV corresponding to the time count value TC2 may be acquired by referring to the lookup table.

FIG. 8 is a diagram illustrating an example of the lookup table that associates the time count value TC2 with the weight value WV. In the lookup table of FIG. 8, when the time count value TC2 is 10 or less, 11 to 15, 16 to 20, and 21 or more, the weight value WV is set to 1, 2, 4, and 8, respectively. In the operation example of FIG. 7, the time count value TC2 is 27, and the weight value WV would be set to 8.

The fact that the time count value TC2 is large indicates that photons are continuously incident during a short time after the time corresponding to the time count value TC1, and it is considered that the probability that a distinct object is present in the vicinity of the distance corresponding to the time count value TC1 is high. Therefore, in the lookup table of FIG. 8, the weight value WV is set to a larger value as the time count value TC2 is larger so that the accumulated value in the time width with high probability of the presence of the object is preferentially increased.

The weighting according to the time count value TC2 is not limited to the example of FIG. 8 and may be appropriately changed according to the measurement conditions, the measurement environment, and the like. For example, in the example of FIG. 8, the weight value WV is set to a value of a power of 2, but the weight value WV does not necessarily need to be a value of a power of 2, and may be set to increase at equal intervals, for example. The range of the time count value TC2 corresponding to each value of the weight value WV may also be arbitrarily set.

The weight determination unit 172 transfers the time count value TC1 acquired from the time information acquisition unit 150 and the weight value WV acquired based on the time count value TC2 to the histogram information generation unit 174. The histogram information generation unit 174 accumulates the weight value WV acquired from the weight determination unit 172 for each light emission of the pulsed light for each time count value TC1 and generates histogram information for each pixel 112. In the case of the operation example of FIG. 7, eight of the weight value WV acquired from the weight determination unit 172 is added to the accumulated value of the time count value TC1 up to that time.

By generating the histogram information in this manner, it is possible to increase the difference between the accumulated value in the time count value TC1 in which the probability that an object is present is high and the accumulated value in another time count value TC1 due to ambient light or noise. Therefore, more accurate distance information may be acquired.

The number of photon detection pulses superimposed on the signal OUT may be counted, and the weight value WV may be weighted according to the count value of the light reception pulse signal. However, in the case where the weighting of the weight value WV is performed according to the count value of the photon detection pulse, if a plurality of photons is continuously incident in a short time, the APD may not be recharged in time, and the photon detection pulse may not be accurately counted. For example, in the operation example of FIG. 7, the count value corresponding to the incidence of photons at times t11, t13, and t14 is one, and appropriate weighting corresponding to the three incidences of photons cannot be performed.

In contrast, in the present embodiment, since the value (weight value WV) to be accumulated is weighted according to the time width of the photon detection pulse superimposed on the signal OUT, it is possible to appropriately consider an increase in the time width of the photon detection pulse according to the incidence of photons at the times t11, t13, and t14. Accordingly, even when the pulse width of the pulsed light emitted from the light emitting unit 10 is short and a plurality of photons are continuously incident on the light receiving unit 20 in a short time, the weight value WV may be appropriately weighted, and more accurate distance information may be acquired.

In addition, the generation rate (dark count rate) of the noise signal (dark pulse) detected when there is no incident light is sufficiently lower than the incidence rate of the photons incident on the light receiving unit 20 due to the pulsed light emitted from the light emitting unit 10. Therefore, the probability that unnecessary weighting is performed on the dark pulse is low, and a decrease in the distance measurement accuracy due to the dark pulse is suppressed.

As described above, according to the present embodiment, it is possible to realize a photoelectric conversion device capable of outputting an appropriate signal according to the incidence frequency of a photon to a pixel, and a ranging device having high ranging accuracy using such a photoelectric conversion device.

### Second Embodiment

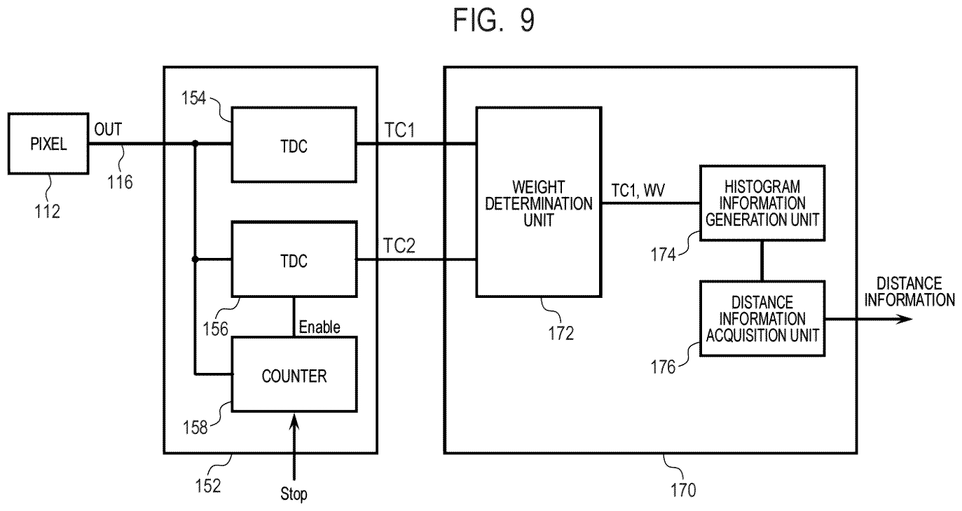

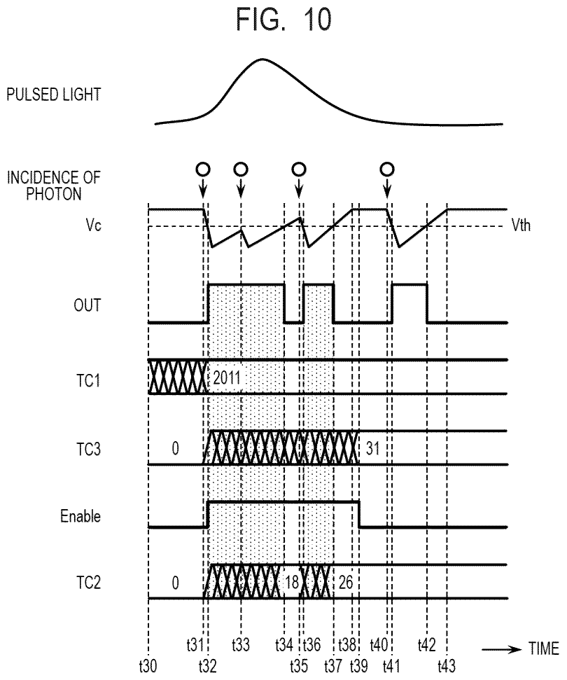

A ranging device and a ranging method according to a second embodiment of the present invention will be described with reference to FIG. 9 and FIG. 10. The same components as those of the ranging device according to the first embodiment are denoted by the same reference numerals, and description thereof will be omitted or simplified. FIG. 9 is a block diagram illustrating a configuration example of a signal processing unit in a ranging device according to the present embodiment. FIG. 10 is a timing chart illustrating the operation of the ranging device according to the present embodiment.

The ranging device according to the present embodiment is the same as the ranging device 100 according to the first embodiment except that the configuration of the signal processing unit 30 is different. In the present embodiment, differences from the ranging device according to the first embodiment will be mainly described, and description of points similar to those of the ranging device according to the first embodiment will be appropriately omitted.

As described above, the signal processing unit 30 may be configured by the time information acquisition unit 150 and the signal processing circuit unit 170 of the photoelectric conversion device 200. The signal processing unit 30 of the present embodiment is different from that of the first embodiment in the configuration of the column information acquisition unit 152. That is, as illustrated in FIG. 9, the column information acquisition unit 152 of the present embodiment further includes a counter 158 in addition to the TDC 154 and the TDC 156. The TDC 154 is connected to the output line 116 and the weight determination unit 172. The TDC 156 is connected to the output line 116, the counter 158, and the weight determination unit 172. The counter 158 is connected to the output line 116 and the TDC 156. The configuration and operation of the weight determination unit 172, the histogram information generation unit 174, and the distance information acquisition unit 176 are the same as those in the first embodiment.

The signal OUT output from the pixel 112 is input to the TDC 154, the TDC 156, and the counter 158 of the column information acquisition unit 152 via the output line 116 of the corresponding column. Each of the TDC 154, the TDC 156, and the counter 158 performs time counting in a predetermined period. The time counting may be performed by, for example, a method of counting the number of pulses superimposed on the clock signal.

Specifically, the TDC 154 performs the time counting from the timing at which the count control signal synchronized with the light emission control signal transmitted to the light emitting unit 10 is received from the control unit 190 to the timing at which the light reception pulse signal superimposed on the signal OUT is received. In addition, the TDC 154 outputs the count value of the clock pulse in the period from the timing of receiving the count control signal to the timing of receiving the light reception pulse signal to the weight determination unit 172 as the time count value TC1.

The counter 158 starts the time counting operation from the timing at which the light reception pulse signal superimposed on the signal OUT is first received after the light emission of the light emitting unit 10 and ends the time counting operation at the timing at which the time count value reaches a preset value (the value of a signal Stop). Then, the counter 158 outputs, to the TDC 156, an enable signal Enable having a predetermined signal level (here, set to high-level) during the period in which the time counting operation is performed. The value of the signal Stop may be set according to, for example, the pulse width of the pulsed light emitted from the light emitting unit 10.

The TDC 156 performs the time counting operation in a period in which the enable signal Enable received from the counter 158 is at the predetermined signal level (high-level) and the light reception pulse signal is received from the pixel 112. The TDC 156 outputs the count value of the clock pulse in the period in which the enable signal Enable is at the predetermined signal level (high-level) and the light reception pulse signal is received to the weight determination unit 172 as the time count value TC2.

FIG. 10 is a timing chart illustrating a driving example of the ranging device according to the present embodiment. FIG. 10 illustrates the waveform of the pulsed light reflected by the object 210 and then incident on the light receiving unit 20, the incident timing of the photon, the cathode voltage Vc, the signal OUT, the time count values TC1 and TC3, the enable signal Enable, and the time count value TC2. The time count value TC3 is a count value of the counter 158.

The time t30 is an arbitrary time after the pulsed light is emitted from the light emitting unit 10 until the pulsed light is detected as the reflected light 14 by the light receiving unit 20. At the time t30, the photoelectric conversion element 122 is in a standby state in which avalanche multiplication is possible, and the cathode voltage Vc is a voltage corresponding to the voltage VH. The signal OUT is at low-level in response to the cathode voltage Vc higher than the determination threshold value Vth. The time count value TC1 indicates a predetermined count value corresponding to the elapsed time from the timing at which the pulsed light is emitted from the light emitting unit 10, that is, the timing at which the count control signal is received from the control unit 190. The TDC 156 and the counter 158 are reset state, and the time count values TC2 and TC3 are 0. It is assumed that the value of the signal Stop preset in the counter 158 is 31. The enable signal Enable is at low-level in response to the low-level signal OUT.

After the time t30, it is assumed that the reflected light 14 is incident on the light receiving unit 20, and photons are incident on a certain pixel 112 at timings of times t31, t33, t35, and t40, for example, as illustrated in FIG. 10.

When a photon enters the photoelectric conversion element 122 at the time t31, an electron-hole pair is generated by photoelectric conversion, avalanche multiplication occurs using these carriers as seeds, and an avalanche multiplication current flows through the photoelectric conversion element 122. As a result, a voltage drop occurs, and the cathode voltage Vc starts to drop.

At the subsequent time t32, when the cathode voltage Vc falls below the determination threshold value Vth, the signal level of the signal OUT output from the waveform shaping circuit 132 transitions from low-level to high-level. The TDC 154 stops the time counting operation in response to the rise of the signal OUT. The counter 158 starts the time counting operation in response to the first rise of the signal OUT and controls the enable signal Enable from low-level to high-level. The TDC 156 starts the time counting operation in response to the rise of the signal OUT and the enable signal Enable at high-level.

After the time t32, when the voltage drop amount of the cathode of the APD increases and the avalanche multiplication in the photoelectric conversion element 122 stops, the voltage level of the cathode voltage Vc does not drop any more. When the avalanche multiplication in the photoelectric conversion element 122 stops, the cathode voltage Vc gradually increases.

If a photon enters the photoelectric conversion element 122 again at the time t33 before the cathode voltage Vc reaches the determination threshold value Vth, avalanche multiplication occurs in the photoelectric conversion element 122, and the cathode voltage Vc starts to drop again. In such a case, since the cathode voltage Vc does not exceed the determination threshold value Vth, the signal level of the signal OUT is maintained at high-level.

After the time t33, when the voltage drop amount of the cathode of the APD becomes large and the avalanche multiplication in the photoelectric conversion element 122 stops, the voltage level of the cathode voltage Vc does not drop any more. When the avalanche multiplication in the photoelectric conversion element 122 stops, the cathode voltage Vc gradually increases.

At the subsequent time t34, when the cathode voltage Vc reaches the determination threshold value Vth, the signal level of the signal OUT transitions from high-level to low-level. The TDC 156 stops the time counting operation in response to the fall of the signal OUT. At this time, it is assumed that the time count value TC2 of the TDC 156 is 18.

At the subsequent time t35, when a photon enters the photoelectric conversion element 122, an electron-hole pair is generated by photoelectric conversion, avalanche multiplication occurs using these carriers as seeds, and an avalanche multiplication current flows through the photoelectric conversion element 122. As a result, the cathode voltage Vc starts to drop.

At the subsequent time t36, when the cathode voltage Vc falls below the determination threshold value Vth, the signal level of the signal OUT output from the waveform shaping circuit 132 transitions from low-level to high-level. The TDC 154 stops the time counting operation at the time t32 and does not respond to the second and subsequent rises of the signal OUT. The TDC 156 receives the rise of the signal OUT and the enable signal Enable at high-level and restarts the time counting operation from the count value 18.

After the time t36, when the voltage drop amount of the cathode of the APD increases and the avalanche multiplication in the photoelectric conversion element 122 stops, the voltage level of the cathode voltage Vc does not drop any more. When the avalanche multiplication in the photoelectric conversion element 122 stops, the cathode voltage Vc gradually increases.

At the subsequent time t37, when the cathode voltage Vc reaches the determination threshold value Vth, the signal level of the signal OUT transitions from high-level to low-level. The TDC 156 stops the time counting operation in response to the fall of the signal OUT. At this time, it is assumed that the time count value TC2 of the TDC 156 is 26. The time count value TC2 at this time is obtained by accumulating a count value corresponding to the pulse width of the light reception pulse signal rising from the time t32 to the time t34 and a count value corresponding to the pulse width of the light reception pulse signal rising from the time t36 to the time t37.

At the subsequent time t38, the cathode voltage Vc is settled to the original voltage corresponding to the voltage VH. The photoelectric conversion element 122 enters a standby state in which avalanche multiplication can be performed.

At the subsequent time t39, it is assumed that the time count value TC3 of the counter 158 has reached the value of the signal Stop set in advance. Then, the counter 158 stops the time counting operation and controls the enable signal Enable from high-level to low-level.

At the subsequent time t40, when a photon enters the photoelectric conversion element 122, an electron-hole pair is generated by photoelectric conversion, avalanche multiplication occurs using these carriers as seeds, and an avalanche multiplication current flows through the photoelectric conversion element 122. As a result, the cathode voltage Vc starts to drop.

At the subsequent time t41, when the cathode voltage Vc falls below the determination threshold value Vth, the signal level of the signal OUT output from the waveform shaping circuit 132 transitions from low-level to high-level. The TDC 154 stops the time counting operation at the time t32 and does not respond to the second and subsequent rises of the signal OUT. The TDC 156 receives the enable signal Enable at low-level and does not restart the time counting operation.

After the time t41, when the voltage drop amount of the cathode of the APD becomes large and the avalanche multiplication in the photoelectric conversion element 122 stops, the voltage level of the cathode voltage Vc does not drop any more. When the avalanche multiplication in the photoelectric conversion element 122 stops, the cathode voltage Vc gradually increases.

At the subsequent time t42, when the cathode voltage Vc reaches the determination threshold value Vth, the signal level of the signal OUT transitions from high-level to low-level.

At the subsequent time t43, the cathode voltage Vc is settled to the original voltage corresponding to the voltage VH. The photoelectric conversion element 122 enters a standby state in which avalanche multiplication can be performed. Thereafter, the same operation as that, for example, from time t40 to time 43 is repeated until a count control signal corresponding to the next light emission timing of the light emitting unit 10 is received.

When the information acquisition period corresponding to one pulsed light emission elapses, the time information acquisition unit 150 sequentially transfers the time count values TC1 and TC2 held by the column information acquisition unit 152 of each column to the signal processing circuit unit 170 according to the control signal from the horizontal scanning circuit unit 160. The time count values TC1 and TC2 transferred to the signal processing circuit unit 170 are input to the weight determination unit 172. Here, it is assumed that the time count value TC1 held by the TDC 154 is 2011, and the time count value TC2 held by the TDC 156 is 26.

The weight determination unit 172 determines the weight value WV based on the time count value TC2 acquired from the time information acquisition unit 150, for example, in the same manner as in the first embodiment. In the case of the operation example of FIG. 10, the time count value TC2 is 26, and the weight value WV is 8, for example, according to the lookup table of FIG. 8.

The weight determination unit 172 transfers the time count value TC1 acquired from the time information acquisition unit 150 and the weight value WV acquired based on the time count value TC2 to the histogram information generation unit 174. The histogram information generation unit 174 accumulates the weight value WV acquired from the weight determination unit 172 for each light emission of the pulsed light for each time count value TC1 and generates histogram information for each pixel 112. In the case of the operation example of FIG. 10, eight of the weight value WV acquired from the weight determination unit 172 is added to the accumulated value of the time count value TC1 up to that point.

By generating the histogram information in this manner, it is possible to increase the difference between the accumulated value in the time count value TC1 in which the probability that an object is present is high and the accumulated value in another time count value TC1 due to ambient light or noise. Therefore, more accurate distance information may be acquired. Further, in the first embodiment, the time count is performed only in the first high-level period of the OUT signal, but in the present embodiment, even if the OUT signal returns to low-level, the time count in the next high-level period may be restarted if the OUT signal is in the enable period. This makes it possible to acquire the time count value TC2 in accordance with the number of photons incident due to the pulsed light emitted from the light emitting unit 10.

As described above, according to the present embodiment, it is possible to realize a photoelectric conversion device capable of outputting an appropriate signal according to the incidence frequency of a photon to a pixel, and a ranging device having high ranging accuracy using such a photoelectric conversion device.

In the present embodiment, the weight value WV is determined based on the total time count value TC2 in the period in which the enable signal Enable is at the predetermined signal level and the light reception pulse signal is received, but the weight value WV may be determined for each light reception pulse signal. For example, the weight value WV may be determined based on the time count value TC2 for each reception period of the received light pulse signal, and a final weight value WV may be obtained by adding a plurality of weight values WV acquired.

Further, a counter for counting the number of light reception pulse signals incident in a period in which the enable signal Enable becomes a predetermined signal level may be further provided, and the weight value WV may be determined in consideration of the count value of the light reception pulse signals in addition to the time count value TC2.

### Third Embodiment

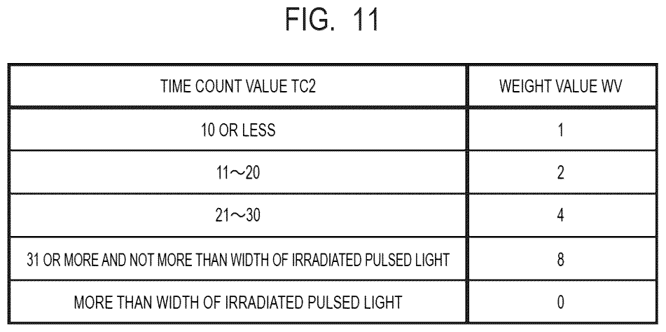

A ranging device and a ranging method according to a third embodiment of the present invention will be described with reference to FIG. 11. The same components as those of the ranging device according to the first or second embodiment are denoted by the same reference numerals, and description thereof will be omitted or simplified. FIG. 11 is a diagram illustrating an example of processing of a weight determination unit in the ranging device according to the present embodiment.

The ranging device according to the present embodiment is the same as the ranging device according to the first or second embodiment except that the processing in the weight determination unit 172 is different. In the present embodiment, differences from the ranging devices according to the first and second embodiments will be mainly described, and description of points similar to those of the ranging devices according to the first and second embodiments will be appropriately omitted.

In the first and second embodiments, the larger the time count value TC2 is, the larger the weighting given to the weight value WV is. On the other hand, in the present embodiment, when the time count value TC2 is equal to or less than a predetermined threshold value, the weighting is increased as the time count value TC2 increases, and when the time count value TC2 is greater than the threshold value, the weighting is decreased. For example, as in the lookup table illustrated in FIG. 11, when the time count value TC2 is 10 or less, 11 to 20, 21 to 30, 31 or more and not more than the width of the pulsed light, or more than the width of the pulsed light, the weight value WV is set to 1, 2, 4, 8, or 0, respectively.

When the pulsed light emitted from the light emitting unit 10 is received by the light receiving unit 20, it is considered that the probability that the time count value TC2 measured by the TDC 156 becomes equal to or less than the value corresponding to the width of the pulsed light is high. Therefore, when the time count value TC2 is equal to or less than the value corresponding to the pulse width of the pulsed light emitted from the light emitting unit 10, the larger the time count value TC2 is, the larger the weighting given to the weight value WV is.

On the other hand, when the time count value TC2 measured by the TDC 156 is larger than the value corresponding to the pulse width of the pulsed light, there is a high probability that the pulsed light emitted from the light emitting unit 10 is not detected but disturbance light having a high intensity and a long period is detected. Therefore, when the time count value TC2 is larger than the value corresponding to the pulse width of the pulsed light emitted from the light emitting unit 10, the weighting given to the weight value WV is lowered. Since the disturbance light is not originally desired to be counted when the histogram information is generated, the degree of contribution of the disturbance light to the histogram information may be lowered by lowering the weighting.

From such a viewpoint, the threshold value used for the determination may be determined according to, for example, the pulse width of the pulsed light emitted from the light emitting unit 10. In the ranging device, the width of the pulsed light emitted from the light emitting unit 10 is managed, and it is possible to acquire in advance how much the time count value TC2 becomes when the pulse width of the pulsed light is measured by the TDC 156.

The weight value WV when the time count value TC2 is larger than the threshold value is not necessarily 0 and may be a value smaller than the maximum value of the weight value WV set when the time count value TC2 is equal to or smaller than the threshold value.

As described above, according to the present embodiment, it is possible to realize a photoelectric conversion device capable of outputting an appropriate signal according to the incidence frequency of a photon to a pixel, and a ranging device having high ranging accuracy using such a photoelectric conversion device.

### Fourth Embodiment

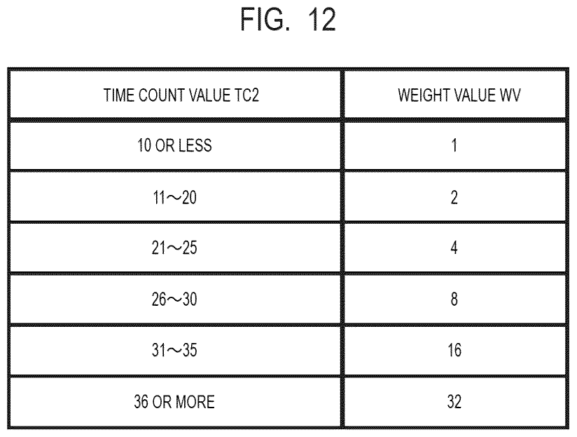

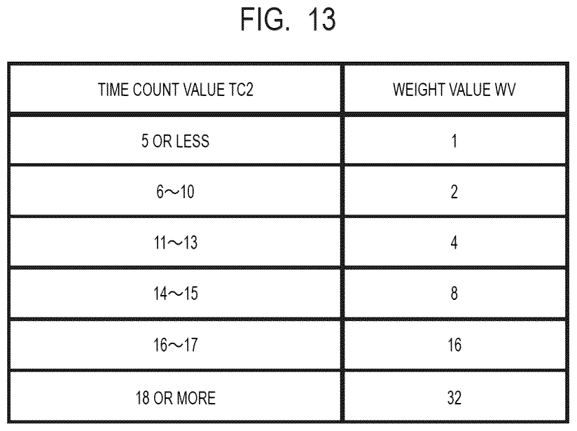

A ranging device and a ranging method according to a fourth embodiment of the present invention will be described with reference to FIG. 12 and FIG. 13. The same components as those of the ranging device according to the first to third embodiments are denoted by the same reference numerals, and description thereof will be omitted or simplified. FIG. 12 and FIG. 13 are diagrams illustrating an example of processing of the weight determination unit in the ranging device according to the present embodiment.

The ranging device according to the present embodiment is the same as the ranging device according to the first to third embodiments except that the processing in the weight determination unit 172 is different. In the present embodiment, differences from the ranging devices according to the first to third embodiments will be mainly described, and description of points similar to those of the ranging devices according to the first to third embodiments will be appropriately omitted.

The present embodiment is common to the first to third embodiments in that the weighting to be given to the weight value WV is changed according to the time count value TC2 but is different from the first to third embodiments in that the operation state of the photoelectric conversion element 122 is further considered.

The response speed of the APD is improved, for example, as the operating temperature is lower, and the recharge voltage is higher. Therefore, even if a photon enters the photoelectric conversion element 122 at the same timing, the time count value TC2 may change according to the operation state of the photoelectric conversion element 122.

For example, the value of the time count value TC2 when the photoelectric conversion element 122 is at a high temperature is larger than the value of the time count value TC2 when the photoelectric conversion element 122 is at a low temperature. Therefore, in the present embodiment, the weight to be given to the weight value WV is determined in consideration of the operation state of the photoelectric conversion element 122 in addition to the time count value TC2.

The weight determination unit 172 may hold, for example, two types of lookup tables as illustrated in FIG. 12 and FIG. 13. FIG. 12 is an example of a lookup table that can be applied when the photoelectric conversion element 122 is at a high temperature (e.g., 60° C.) or when the recharge voltage is low. FIG. 13 is an example of a lookup table that can be applied when the photoelectric conversion element 122 is at a low temperature (e.g., 0° C.) or when the recharge voltage is high. In the lookup table of FIG. 12, when the time count value TC2 is 10 or less, 11-20, 21-25, 26-30, 31-35, or 36 or more, the weight value WV is set to 1, 2, 4, 8, 16, or 32, respectively. In the lookup table of FIG. 13, when the time count value TC2 is 5 or less, 6-10, 11-13, 14-15, 16-17, or 18 or more, the weight value WV is set to 1, 2, 4, 8, 16, or 32, respectively.

By setting the weighting of the weight value WV in this manner, it is possible to give a stable weight to the weight value WV in accordance with the incident timing of the photon regardless of the operation state of the photoelectric conversion element 122. As a result, it is possible to reduce variations in distance measurement operation and improve distance measurement accuracy.

As described above, according to the present embodiment, it is possible to realize a photoelectric conversion device capable of outputting an appropriate signal according to the incidence frequency of a photon to a pixel, and a ranging device having high ranging accuracy using such a photoelectric conversion device.

Although two lookup tables are prepared according to the operation status of the photoelectric conversion element 122 in the present embodiment, three or more lookup tables may be prepared.

### Fifth Embodiment

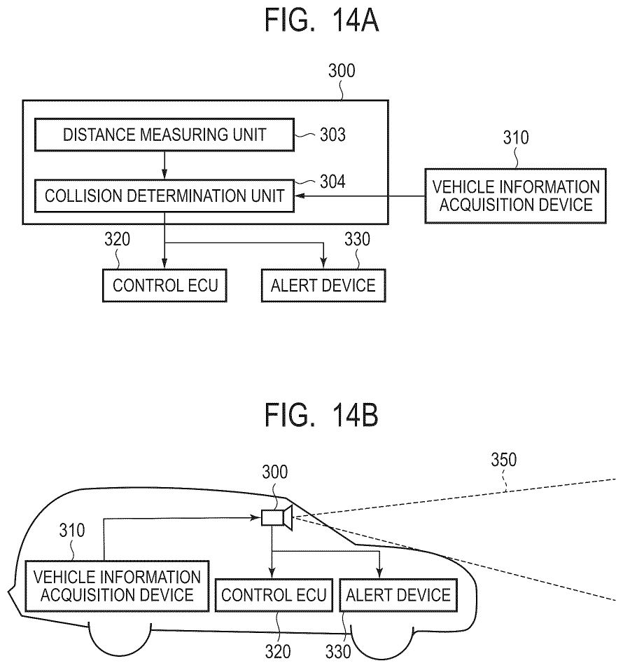

A movable object according to a fifth embodiment of the present invention will be described with reference to FIG. 14A and FIG. 14B. FIG. 14A and FIG. 14B are diagrams illustrating a configuration example of movable object according to the present embodiment.

FIG. 14A illustrates a configuration example of equipment mounted on a vehicle as an in-vehicle camera. The equipment 300 includes a distance measuring unit 303 that measures a distance to an object, and a collision determination unit 304 that determines whether there is a possibility of collision based on the distance measured by the distance measuring unit 303. The distance measuring unit 303 is configured by the ranging device 100 described in any of the first to fourth embodiments. Here, the distance measuring unit 303 is an example of a distance information acquisition unit that acquires distance information to an object. That is, the distance information is information related to a distance to an object or the like.

The equipment 300 is connected to the vehicle information acquisition device 310 and may acquire vehicle information such as a vehicle speed, a yaw rate, and a steering angle. In addition, a control ECU 320, which is a control device that outputs a control signal for generating a braking force to the vehicle based on the determination result of the collision determination unit 304, is connected to the equipment 300. The equipment 300 is also connected to an alert device 330 that issues an alert to the driver based on the determination result of the collision determination unit 304. For example, when the determination result of the collision determination unit 304 indicates that the possibility of collision is high, the control ECU 320 performs vehicle control to avoid collision and reduce damage by, for example, applying a brake, returning an accelerator, or suppressing engine output. The alert device 330 gives an alert to the user by sounding an alarm such as a sound, displaying alert information on a screen of a car navigation system or the like, giving vibration to a seat belt or a steering wheel, or the like. These devices of the equipment 300 function as a movable object control unit that controls the operation of controlling the vehicle as described above.

In the present embodiment, the distance to the surroundings of the vehicle, for example, the front or the rear is measured by the equipment 300. FIG. 14B illustrates the equipment in the case of distance measurement in front of the vehicle (distance measurement range 350). The vehicle information acquisition device 310 serving as the distance measurement control unit sends an instruction to the equipment 300 or the distance measuring unit 303 to perform the distance measurement operation. With such a configuration, the accuracy of distance measurement may be further improved.

Although an example in which control is performed so as not to collide with another vehicle has been described above, the present invention is also applicable to control in which automatic driving is performed so as to follow another vehicle, control in which automatic driving is performed so as not to protrude from a lane, and the like. Furthermore, the equipment is not limited to vehicles such as automobiles and may be applied to the other movable objects (mobile devices), for example, ships, aircrafts, artificial satellites, industrial robots, consumer robots, and the like. In addition, the present invention is not limited to the movable objects and may be widely applied to equipment utilizing object recognition or biological recognition, such as ITS (Intelligent Transport Systems) and monitoring systems.

### Modified Embodiments

The present invention is not limited to the above-described embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present invention.

Further, in the first to fourth embodiments, the example in which the column information acquisition unit 152 provided for each column of the pixel unit 110 is included in the time information acquisition unit 150 has been described, but the function corresponding to the column information acquisition unit 152 is not necessarily included in the time information acquisition unit 150. For example, the functions corresponding to the column information acquisition unit 152, that is, the TDC 154, the TDC 156, and the counter 158 may be included in each of the plurality of pixels 112 included in the pixel unit 110. In this case, the time count values TC1 and TC2 may be held in the respective pixels 112 and may be output to the time information acquisition unit 150 row by row according to a control signal from the pixel driving unit 140. By configuring the pixels 112 in this manner, it is possible to simultaneously acquire distance information for one irradiation of pulsed light in the plurality of pixels 112 configuring the pixel unit 110, and it is possible to acquire a distance image with higher temporal accuracy. The time information acquisition unit 150 may be provided with a plurality of signal holding units corresponding to each of the plurality of pixels 112 constituting the pixel unit 110, and signals of the plurality of pixels 112 may be collectively transferred to the time information acquisition unit 150.

In the first to fourth embodiments, the light emitting unit 10 and the light receiving unit 20 are described as a part of the components of the ranging device 100, but at least one of the light emitting unit 10 and the light receiving unit 20 does not necessarily need to be a part of the configuration of the ranging device 100.

Although the ranging device has been described in the first to fourth embodiments, the algorithm described in the above embodiments may also be applied to an information processing device for processing a signal output from the light receiving unit 20. In this case, the input unit to which a signal is input and the signal processing unit 30 may constitute the information processing device. The information processing device may be a device such as a personal computer including a processor (for example, a CPU or an MPU). Alternatively, the information processing device may be a circuit such as an ASIC that implements the functions of the input unit to which a signal is input and the signal processing unit 30.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for carrying out the present invention, and the technical scope of the present invention should not be interpreted in a limited manner by these embodiments. That is, the present invention can be implemented in various forms without departing from the technical idea or the main features thereof.

According to the present invention, it is possible to realize a photoelectric conversion device capable of outputting an appropriate signal according to the incidence frequency of photons on a pixel, and a ranging device having high ranging accuracy using such a photoelectric conversion device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-167378, filed Sep. 28, 2023, which is hereby incorporated by reference herein in its entirety.

What is claimed is:

1. A photoelectric conversion device comprising:
a light receiving unit configured to generate a light reception pulse signal in response to incidence of light;
a time information acquisition unit configured to acquire, for each periodic light emission of a light emitting unit, a first time count value indicating an elapsed time from a light emission of the light emitting unit to an input of the light reception pulse signal, and a second time count value indicating a pulse width of the light reception pulse signal; and
a weight determination unit configured to generate a weight value corresponding to the second time count value as a signal used to generate information indicating a relationship between each of the first time count values and a light reception frequency.

2. The photoelectric conversion device according to claim 1, wherein the information is generated by accumulating, for each periodic light emission of the light emitting unit, the weight value as a value representing the light reception frequency corresponding to the first time count value.

3. The photoelectric conversion device according to claim 1, wherein the time information acquisition unit includes a first time digital conversion unit configured to acquire the first time count value, and a second time digital conversion unit configured to acquire the second time count value.

4. The photoelectric conversion device according to claim 1, wherein the time information acquisition unit is configured to acquire the first time count value and the second time count value with respect to the light reception pulse signal input first after the light emission of the light emitting unit.

5. The photoelectric conversion device according to claim 1, wherein the time information acquisition unit is configured to accumulate count values corresponding to pulse widths of the light reception pulse signals input during a period from when the light reception pulse signal is first input after the light emission of the light emitting unit to when a predetermined period elapses and set as the second time count value.

6. The photoelectric conversion device according to claim 5, wherein the time information acquisition unit further includes a counter configured to perform a time counting during the period from when the light reception pulse signal is first input to when the predetermined period elapses.

7. The photoelectric conversion device according to claim 1, wherein the weight determination unit is configured to set the weight value to a larger value as the second time count value is larger.

8. The photoelectric conversion device according to claim 1, wherein the weight determination unit is configured to set the weight value to a larger value as the second time count value is large when the second time count value is equal to or less than a predetermined threshold value, and set the weight value to a value smaller than a maximum value of the weight value set in a case that the second time count value is equal to or less than the predetermined threshold value when the second time count value is greater than the predetermined threshold value.

9. The photoelectric conversion device according to claim 1,
wherein the light receiving unit includes a SPAD, and
wherein the weight determination unit is configured to set the weight value such that the weight value when an operation temperature of the SPAD is a first temperature is larger than the weight value when an operation temperature of the SPAD is a second temperature higher than the first temperature.

10. The photoelectric conversion device according to claim 1,
wherein the light receiving unit includes a SPAD, and
wherein the weight determination unit is configured to set the weight value such that the weight value when a recharge voltage of the SPAD is a first voltage is larger than the weight value when a recharge voltage of the SPAD is a second voltage lower than the first voltage.

11. The photoelectric conversion device according to claim 1, wherein the weight determination unit includes a lookup table indicating a correspondence relationship between the second time count value and the weight value.

12. The photoelectric conversion device according to claim 1,
wherein the light receiving unit includes a plurality of pixels each including a photoelectric conversion element, and
wherein the time information acquisition unit and the weight determination unit perform processing on a signal for each of the plurality of pixels.

13. The photoelectric conversion device according to claim 1 further comprising:
an information generation unit configured to generate information indicating a relationship between each of the first time count values and a light reception frequency by accumulating, for each periodic light emission of the light emitting unit, the weight value as a value representing the light reception frequency for the corresponding first time count value, and
a distance information acquisition unit configured to acquire distance information corresponding to a first time count value having largest accumulated value out of the weight values among the plurality of first time count values.

14. A ranging device comprising:
a light receiving unit configured to generate a light reception pulse signal in response to incidence of light;
a time information acquisition unit configured to acquire, for each periodic light emission of a light emitting unit, a first time count value indicating an elapsed time from a light emission of the light emitting unit to an input of the light reception pulse signal, and a second time count value indicating a pulse width of the light reception pulse signal;
a weight determination unit configured to generate, for each periodic light emission of the light emitting unit, a weight value corresponding to the second time count value;
an information generation unit configured to generate information indicating a relationship between each of the first time count values and a light reception frequency by accumulating, for each periodic light emission of the light emitting unit, the weight value output from the weight determination unit as a value representing the light reception frequency for the corresponding first time count value; and
a distance information acquisition unit configured to acquire distance information corresponding to a first time count value having largest accumulated value of the weight value among the first time count values.

15. A movable object comprising:
the ranging device according to claim 14; and
a control unit configured to control the movable object based on the distance information acquired by the ranging device.

16. An information processing device including:
an input unit to which a first time count value indicating an elapsed time from a light emission of a light emitting unit to a reception of a light reception pulse signal, and a second time count value indicating a pulse width of the light reception pulse signal are periodically input;
a weight determination unit configured to generate, for each reception of the first time count value and the second time count value, a weight value corresponding to the second time count value;
an information generation unit configured to generate information indicating a relationship between each of the first time count values and a light reception frequency by accumulating, for each reception of the first time count value and the second time count value, the weight value output from the weight determination unit as a value representing the light reception frequency for the corresponding first time count value; and
a distance information acquisition unit configured to acquire distance information corresponding to a first time count value having largest accumulated value of the weight value among the first time count values.
